(19) United States
(12) Patent Application Publication
(10) Pub. No.: US 2012/0315622 A1
(43) Pub. Date: Dec. 13, 2012

(54) SYSTEM FOR DETECTING AND ENUMERATING BIOLOGICAL PARTICLES

(76) Inventor: M. Boris Rotman, Phoenix, AZ (US)

(21) Appl. No.: 13/466,186

(22) Filed: May 8, 2012

Related U.S. Application Data
(60) Provisional application No. 61/518,535, filed on May 9, 2011.

(51) Int. Cl. G01N 21/64

(52) U.S. Cl. 435/5; 435/34; 435/31

(57) ABSTRACT

The invention discloses a system to detect and enumerate diverse biological particles through the use of microbial spores that in the presence of a redox substrate rapidly respond to germination signals by forming discrete intracellular fluorescent formazan granules. The disclosed system enables ultrasensitive detection and enumeration of different analytes including microorganisms, viruses, nucleic acids, polypeptides, and natural or man-made particles bearing analytes.

### CROSS REFERENCE TO RELATED APPLICATION

This application claims the benefit of U.S. Provisional Patent Application No. 61/518,535 filed May 9, 2011, which is incorporated by reference herein for all purposes.

### STATEMENT OF GOVERNMENT SUPPORT

The present invention was made with support from the National Institutes of Health under Grant number AI073000. The United States Government has certain rights to this invention.

### BACKGROUND ART

This disclosure is in the fields of biological and biochemical assays. More specifically, it is directed to analytical systems using living microbial spores as sensing components in devices for detecting and enumerating pathogenic microorganisms, macromolecules and other analytes directly from a test sample.

Living microbial spores have previously been used to sense specific signals from analytes and to respond by establishing an analyte-independent signal amplification system. For example, U.S. Pat. No. 6,872,539 (Rotman) discloses methodologies that provide a particularly efficient technique to conduct thousands of parallel assays in a biosensor comprising a vast array of about 80,000 independent microscopic biosensors (termed 80K-bioChip™). These methodologies teach a label-free, growth-independent, analytical system (termed “LEXSAS™”) using enzyme-free spores for rapid detection and identification of different analytes directly from a test sample. In that invention, the test material is mixed with a germinogenic source and enzyme-free spores prepared from selected bacterial strains. The mixture stands for 5-7 minutes to allow for analyte-induced spore germination and subsequent de novo synthesis of an enzyme capable of producing a germinant in the presence of a germinogenic source. The germinant promotes further spore germination with concomitant de novo enzyme synthesis that results in a propagating cascade of analyte-independent germination. The end point of the cascade can be monitored using an assortment of physical and enzymatic parameters, e.g., loss of spore refractility and hydrolysis of chromogenic, fluorogenic, or indigogenic substrates.

A limiting factor when using the chromogenic or fluorogenic substrates in the 80K-bioChip™ is diffusion of the colored or fluorescent product, respectively. The present invention circumvents the problem by using a redox substrate that upon reduction produces an insoluble fluorescent formazan. An example of such a substrate is 5-cyano-2,3-ditolyl tetrazolium chloride (CTC), which upon reduction produces an insoluble red fluorescent formazan. CTC has been extensively used to measure redox reactions in eukaryotic and prokaryotic cells (G. G. Rodriguez, et al., “Use of a fluorescent redox probe for direct visualization of actively respiring bacteria.” (1992) Appl. Environ. Microbiol. 58:1801-1808).

The present invention exploits a previously unknown physiological property of spores, including Bacillus spores, namely, that dormant spores in the presence of CTC and a specific germinant rapidly (within 5-6 minutes) produce intracellular, red-fluorescent, formazan granules. Such granules may be about 150 nm, and are clearly visible under confocal microscopy and can be used to quantify the extent of redox activity by fluorimetry.

Therefore, the discovery of CTC formazan (CTCF) compartmentalization in germinating spores serves to significantly improve the sensitivity of the LEXSAS™, the 80K-bioChip™, or that of similar systems by eliminating the problem of fluorescent product diffusion. It should be noted that dormant spores do not reduce CTC in the absence of a germinant.

### DETAILED DESCRIPTION

Embodiments of the invention include methods for detecting an analyte in a sample by: providing a sample; providing a plurality of spores, the spores requiring a germinant in order to germinate, the germinant being associated with the analyte; contacting the spores with the sample; incubating the spores in contact with the sample for a time sufficient to allow for the spores to germinate in response to the first germinant; contacting the spores with a fluorogenic substrate, the substrate configured to produce intracellular fluorescent granules in response to spore germination; incubating the spores in contact with the substrate for a time sufficient to allow for the production of the intracellular fluorescent granules. A co-germinant not associated with the analyte, but which is required in order to enable germination may also be provided. According to one embodiment, the sample is prepared by treating a material to select for an analyte, and the sample is the result of such treatment. A germinant can be “associated” with an analyte as follows: (i) the germinant can be the analyte, (ii) the germinant can be produced by the analyte (e.g., secreted by the analyte, produced by a reaction between the analyte and another reactant, produced by a reaction between a component of the analyte and another reactant, or produced by a reaction catalyzed by an enzyme of the analyte), (iii) the germinant can be linked or bonded to the analyte (e.g., immuno-linked or labeled).

Specifically, the analytical method entails the steps of: Placing a sample suspected of containing the analyte in a mixture of spores, a germinogenic source and CTC. The end point is an intense red-fluorescent signal that can be used to detect, enumerate, and quantify analytes.

Embodiments can also be used to confirm the sterility of a material. In such a process a material and spores are provided, the spores requiring a germinant in order to germinate. The material and the plurality of spores are subjected to a same sterilization process. After the sterilization process, the spores are contacted with a germinant for a time sufficient to allow for the spores to germinate in response to the germinant. The spores are then contacted with a fluorogenic substrate, the substrate configured to produce intracellular fluorescent granules in response to spore germination and incubated with the substrate for a time sufficient to allow for the production of the intracellular fluorescent granules. The amount of intracellular fluorescent granules is measured by any appropriate technique. The amount of intracellular fluorescent granules indicates whether or not the sterilization process was successful. Specifically, if the amount of intracellular fluorescent granules is above a predetermined amount, the sterilization process was not successful and the material was not sterilized.

Embodiments of the present invention also relate to systems for detecting an analyte in a sample. A system according to one embodiment can include a plurality of spores, the spores requiring a germinant in order to germinate, the germinant being associated with the analyte such that the spores germinate in the presence of the analyte; and a fluorogenic substrate in contact with the spores, the substrate configured to produce intracellular fluorescent granules after the onset of spore germination. The system can also include a co-germinant not associated with the analyte, but which is required in order to enable germination. In addition, embodiments of the invention include biosensors for detecting analytes through the use of microbial spores that sense analyte-specific signals and respond to them by establishing an analyte-independent signal amplification system. The invention provide systems that enable rapid detection, identification, and enumeration of different biological particles including microorganisms, viruses, nucleic acids, polypeptides, and natural or man-made particles bearing analytes, as well as assessing spore viability in devices used for sterility assurance.

The usefulness of the present invention is illustrated by an embodiment for detecting coliform bacteria (the analyte) in a sample. In this embodiment, the spores are able to detect the analyte because most coliforms produce β-galactosidase (EC 3.2.1.23), also known as lactase, an enzyme extensively used as a specific marker for fecal contamination of environmental waters. The test system includes a buffer solution containing B. megaterium spores, CTC, and Lactose, a germinogenic substrate releasing D-glucose (a potent, specific germinant of B. megaterium spores) when hydrolyzed by β-galactosidases.

Under appropriate pH and temperature conditions (e.g., pH 6.8-7.8 and 20° C. to 40° C.) coliform bacteria containing β-galactosidase produce D-glucose from lactose hydrolysis, which in turn, triggers spore germination and concomitant fluorescence due to CTCF production. The fluorescence produced by the system can be measured using known methods of fluorometry.

The components and reagents for performing tests according to the present invention may be supplied in the form of a kit in which the simplicity and sensitivity of the methodology are preserved. All necessary reagents can be added in excess to accelerate the reactions. In preferred embodiments, the kit will also comprise a preformed biosensor designed to receive a sample containing an analyte. The exact components of the kit will depend on the type of assay to be performed and the properties of the analyte being tested.

Considering that spores of diverse organisms have common physical and functional properties, it is expected that the present invention will function well with spores prepared from different spore-forming species including bacteria, fungi, plants, and yeast.

Table 1 lists several spore-forming bacteria and corresponding germinants. It should be noted that some spores need two germinants present at the same time (co-germinants) for germination. Also, mutants of spore-forming organisms in which the specificity of the germinant receptor has been altered can also be used for the invention.

TABLE 1
Spore forming bacteria and corresponding spore germinants

| Bacteria | Germinant |
|---|---|
| Bacillus atrophaeus | L-alanine |
| Bacillus anthracis | L-alanine + inosine or adenosine |
| Bacillus cereus | L-alanine + inosine or adenosine |
| Bacillus licheniformis | Glucose, inosine |
| Bacillus megaterium | Glucose, L-proline, KBr |
| Geobacillus stearothermophilus | Complex medium (e.g., TSB broth) |
| Bacillus subtilis | L-alanine |

Detection.

Many of the embodiments of the present invention employ optical detection of spore germination. In a preferred embodiment employing a previously described biosensor (U.S. Pat. No. 6,872,539, Rotman), a charge-coupled device (CCD) readout is used for imaging the response of the system to the analyte in the form of discrete fluorescent Micro-Colanders® randomly distributed throughout the 80K-bioChip™.

### EXAMPLES

The following non-limiting examples provide results that demonstrate the effectiveness of using redox activity for spore-based biosensing. All parts and percentages are by weight unless otherwise specified.

### Example 1

### Detection of Escherichia coli Containing β-Lactamases

Detection of bacteria containing β-lactamases (EC 3.5.2.6) is clinically important because β-lactamases are usually good markers of bacterial resistance to β-lactam antibiotics. This example illustrates an application of the invention in the LEXSAS™, a biosensing system previously used for detecting low levels of bacteria in near real time (U.S. Pat. No. 6,872,539; and Rotman, B. and Cote, M. A. Application of a real-time biosensor to detect bacteria in platelet concentrates. (2003) Biochem. Biophys. Res. Comm., 300:197-200). This invention enables the LEXSAS™ to function more efficiently than previously observed when fluorogenic compounds (such as diacetyl fluorescein) were used as enzyme substrates.

In this example, E. coli cells (the analyte) produce L-alanine (the germinant) by cleavage of L-alanyl deacetylcephalothin according to the following reaction:

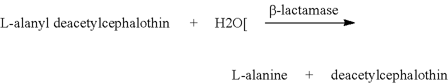

L-alanine deacetylcephalothin, the germinogenic substrate, is a C10 alanyl ester of deacetylcephalothin liberating L-alanine upon enzymatic hydrolysis of the β-lactam ring according to the reaction above. Synthesis of the substrate has been previously described (Mobashery S, and Johnston M. (1987) Inactivation of alanine racemase by β-chloro-L-alanine released enzymatically from amino acid and peptide C10-esters of deacetylcephalothin. Biochem. 26:5878-5884).

Spores.

Spores derived from B. cereus 569H (ATCC 27522), a strain with constitutive β-lactamase II, are used. These spores require mixtures of amino acids and nucleosides for germination, e.g., L-alanine plus inosine. The spores are obtained by growing bacteria in sporulation agar medium (ATCC medium No. 10) at 37° C. for 1-4 days. The spores are harvested with cold deionized water, heated at 65° C. for 30 min (to kill vegetative cells and to inactivate enzymes) and washed three or more times with deionized water. If necessary, the spores may be further purified according to conventional methodologies such as sonication, lysozyme treatment, and gradient centrifugation (Nicholson, W. L., and Setlow, P. (1990). Sporulation, germination, and outgrowth, p. 391-450. in C. R. Harwood and S. M. Cutting (ed.), Molecular biological methods for Bacillus. John Wiley & Sons, Sussex, England). After spore purification, the spores are resuspended in sterile, deionized water and stored at 4° C. Spore suspensions give satisfactory results after storage at this temperature for up to eight months. Alternatively, the spores may be lyophilized for longer storage. Before using the spores in the assay, they are heat-activated at 65° C. for 30 min.

Assay by Detecting Fluorescence of Intracellular Formazan Granules within Spores

The assay is set up in a small Eppendorf tube containing 10 μL of 7.3 mM deacetylcephalothin L-alanine ester (the germinogenic substrate), 10 μL of 100 mM TRIS-100 mM KCl buffer at pH 7.0, and 5 μL of a sample with variable numbers of E. coli cells. The tube is incubated at 37° C. for 30 minutes. After incubation, 30 μL of the tube contents are introduced into a tube containing 10 μL of activated B. cereus spores (2.5×10⁸ spores per mL), 5 μL 1.0 mM inosine, and 5 μL of 40 mM CTC, which had been previously equilibrated at 37° C. After exactly 12 minutes of incubation, the reaction is stopped by adding 10 μL of 250 mM NaN₃ to the tube.

Under these conditions, E. coli cells trigger appearance of fluorescence due to the following interconnected reactions:

(1) E. coli β-lactamase hydrolyses the germinogenic substrate (L-alanyl deacetylcephalothin) liberating L-alanine, which, in turn, induces germination in the spores surrounding the E. coli cells;

(2) Spore germination promotes CTC reduction and formation of intracellular fluorescent CTCF granules;

(3) The course of the reaction is measured fluorometrically.

Appropriate positive and negative controls are included in the test.

CTC reduction is measured in triplicate samples by placing 12 μL of the reaction mixture on Whatman GF/A disks (¼ inch diameter). After drying the disks in a laminar hood for 30-60 minutes, fluorescence images of the disks are acquired and quantified using an image analysis system previously described (Rotman, B. and MacDougall, D. E. Cost-effective true-color imaging system for low-power fluorescence microscopy. (1995) CellVision 2:145-150).

### Example 2

### Detection of Pseudomonas aeruginosa by Aminopeptidase Activity

This is another example illustrating the use of the invention in the LEXSAS™. The bacterial analyte is P. aeruginosa (ATCC 10145), a well known human pathogen.

Enzymatic Production of Germinant.

In this example, cells of P. aeruginosa (the analyte) have aminopeptidases producing L-alanine (the germinant) by hydrolysis of L-alanyl-L-alanine (Ala-Ala), a germinogenic dipeptide that by itself does not induce spore germination. Aminopeptidases belong to an extended family of enzymes that is present in practically all bacterial species and accordingly are considered universal bacterial markers. The biosensor response to bacterial analytes is based on their generating L-alanine from Ala-Ala according to reaction (2).

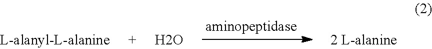

Spores.

Spores derived from B. cereus 569H (ATCC 27522) are prepared as indicated above for Example 1.

Biosensor Operation.

When using this invention in the LEXSAS™, the spores produce fluorescence in response to the presence of bacteria, which in this example are cells of P. aeruginosa. Biosensing is performed in triplicate using glass fiber disks (Whatman GF/A, 6.35 mm diameter) impregnated with a 12 μL volume from a 40 μL reaction mixture containing 4.5×10⁷ spores of B. cereus, 100 mM TRIS-20 mM NaCl buffer, pH 7.4, 0.9 mM Ala-Ala, 0.47 mM inosine, 4 mM CTC, and a variable number of P. aeruginosa cells. Appropriate positive and negative controls are included in the test. The number of P. aeruginosa tested may vary from 30 to 10,000 cells per sample. The disks are incubated in a moist chamber at 37° C. for 15 minutes, and then dried at room temperature for 20 minutes. After drying, fluorescence images of the disks are captured and quantified using an image analysis system similar to that previously described (Rotman, B. and MacDougall, D. E. (1995) Cost-effective true-color imaging system for low-power fluorescence microscopy. CellVision 2:145-150). Disk fluorescence is expressed as “sum of fluorescent pixels” measured inside a square region of 3,600 pixels in the image center.

Negative controls (without P. aeruginosa) are included in each biosensor operation.

### Example 3

### Using the Invention for Cell-Based Biosensing of Biological Warfare Agents

There is an urgent need for new technology capable of monitoring the environment for biological warfare agents in near real time. In this example, the invention is used for detecting biological warfare agents using an assay similar to that of an enzyme-linked immunosorbent assay (ELISA). As in Example 1, the biosensor operates via LEXSAS™ except that in this case the warfare particles are tagged with a germinogenic enzyme. For example, a target biological warfare agent—such as Staphylococcus enterotoxin B—is immuno-captured on magnetic beads and immuno-tagged with a specific antibody covalently linked to alkaline phosphatase to become a suitable particulate analyte.

Spores.

Normal spores derived from B. megaterium (ATCC 14581) are prepared as indicated for Example 1. These spores are germinated specifically by monosaccharides such as D-glucose, D-fructose, D-mannose, and methyl β-D-glucopyranoside. When using B. megaterium spores in the LEXSAS™, suitable germinogenic substrates are, for example, lactose (hydrolyzed by β-galactosidases), sucrose (hydrolyzed by sucrase), glucose-1-phosphate and glucose-6-phosphate (both hydrolyzed by phosphatases).

Biosensor Operation.

Spores of a non-virulent strain of B. anthracis (Sterne strain) are used as subrogates of spores causing anthrax. The spores are first coated with a specific anti-B. anthracis rabbit IgG, and then captured on paramagnetic beads coated with protein A. After separating, washing and blocking the magnetic beads with normal goat IgG, the spores on the beads are exposed to a secondary specific anti-B. anthracis goat IgG labeled with alkaline phosphatase. This process of using two specific antibodies (or other ligands) binding different epitopes for capturing and tagging biological particles is often used to enhance selectivity of a test and also to reduce the baseline noise, and it is critical for achieving high levels of selectivity necessary to avoid false positives. At the end of the process, the phosphatase-labeled beads are magnetically separated, washed, mixed with 5 mM CTC, and then introduced in a biosensor capable of detecting and quantifying individual magnetic beads. The biosensor is a passive microfluidic device fabricated by spin coating a 15 μm thick silicon nitride photoresist on a 13-mm diameter polycarbonate filter membrane with uniform 0.2 μm pores. Subsequently, the silicon layer is photolithographically etched to produce about 80,000 Micro-Colander® biosensors. A Micro-Colander® is a microscopic reaction chamber of about five-picoliter (5×10⁻¹² L) volume that drains through thousands of uniform pores located at the bottom of the chamber (U.S. Pat. No. 6,872,539). Consequently, the biosensor performs as a filtration and collection device for capturing, detecting and enumerating biologically active particles.

For detection and enumeration, fluorescence images of the 80K-bioChip™ are acquired at intervals using a low-power fluorescent microscope (470-550 nm excitation and 620-650 emission) equipped with a digital camera. The fact that each Micro-Colander® functions as an independent biosensor provides for both single bead sensitivity and straight forward quantitative enumeration because the number of fluorescent micro-colanders containing a bead corresponds exactly to the number of beads in the sample.

### Example 4

Using the Invention for Improving the Sensitivity of ELISAs

Enzyme-linked immunosorbent assays (ELISAs) are popular tests for diverse diagnostic analyses. This example illustrates the use of the invention to improve the sensitivity of an ELISA for detecting human immunodeficiency virus (HIV). From this example, it is obvious that someone expert in the field could apply the invention for detecting many other infectious agents.

The analyte is a capsid protein of HIV known as p24 antigen. For testing, a blood plasma sample suspected of containing p24 antigen is mixed with para magnetic microbeads previously coated with a monoclonal antibody against p24. After 30 minutes of incubation, the beads are magnetically separated from the assay mixture, washed and resuspended in a solution containing a different monoclonal antibody against p24 conjugated with β-galactosidase. After another 30-min incubation, the beads are separated, washed, and tested in the 80K-bioChip™ as described above for Example 3, except that B. megaterium spores and lactose are used as detectors and germinogenic substrate, respectively.

### Example 5

### Using the Invention for Biological Indicators to Monitor Sterilization

In this example, the invention is used to monitor steam sterilization using Biological Indicators (BIs) prepared with Geobacillus stearothermophilus spores that have been selectively treated in order to completely destroy their redox activity (due to presence of living cells in the preparation) while leaving them practically 100% viable. When such spores are exposed to inadequate steam sterilization conditions, they will retain ability to rapidly respond to germinants and express redox activity in the presence of CTC.

Preparation of BIs.

A small volume (e.g., 8 μl) of a spore suspension is placed on midpoint of a strip (6×60 mm) of filter paper (Whatman GF/A) and allowed to dry at room temperature. After drying, the strip is packaged inside of a glassine pouch.

To monitor sterilization, the BI is placed in a steam autoclave together with materials to be sterilized. After the sterilization cycle, the strip is removed from the pouch and a drop of a potassium phosphate buffer solution containing a germinant is placed on the spores. The strip is then incubated at 55-60° C. for 20 minutes and another drop of buffer containing 5 mM CTC is placed on the spores. The strip is incubated at 37° C. for 15-min, and after incubation is allowed to dry. After drying, the fluorescence of the spores is quantitatively measured as indicated above for Example 2. Presence of significant fluorescence above a background baseline is indicative of an inadequate sterilization cycle.

What is claimed as new and desired to be protected by Letters Patent of the United States is:

1. A method for detecting an analyte in a sample, the method comprising:
providing a sample;
providing a plurality of spores, the spores requiring a germinant in order to germinate, the germinant being associated with the analyte;
contacting the spores with the sample;
incubating the spores in contact with the sample for a time sufficient to allow for the spores to germinate in response to the germinant;
contacting the spores with a fluorogenic substrate, the substrate configured to produce intracellular fluorescent granules in response to spore germination; and
incubating the spores in contact with the substrate for a time sufficient to allow for the production of the intracellular fluorescent granules.

2. The method of claim 1, further comprising detecting the spores with fluorescent granules by a measurable parameter.

3. The method of claim 1, wherein the spores, sample and substrate are mixed together such that the acts of contacting the spores with the sample and contacting the spores with a fluorogenic substrate occur simultaneously.

4. The method of claim 1, wherein the spores require more than one germinant in order to germinate, wherein the germinant is a first co-germinant, and further comprising providing a second co-germinant, the second co-germinant not being associated with the analyte.

5. The method of claim 4, wherein the analyte is E. coli, the spores are B. cereus, the first germinant is L-alanine and the second germinant is inosine.

6. The method of claim 4, wherein the analyte is P. aeruginosa, the spores are B. cereus, the first germinant is L-alanine and the second germinant is inosine.

7. The method of claim 1, further comprising preparing the sample, the preparing comprising treating a material to select for an analyte, wherein the sample is the result of such treatment.

8. The method of claim 1, wherein the fluorogenic substrate is a tetrazolium salt.

9. The method of claim 8, wherein the tetrazolium salt is 5-cyano-2,3-ditolyl tetrazolium chloride.

10. The method of claim 1, wherein the spores are selected from the group consisting of bacteria, fungi, plants, and yeast.

11. The method of claim 10, wherein the spores are from bacteria of at least one of the genus of Bacillus and Clostridium.

12. The method of claim 1, wherein the analyte is selected from the group consisting of bacteria and viruses.

14. A system for detecting an analyte in a sample, the system comprising:
a plurality of spores, the spores requiring a germinant in order to germinate, the germinant being associated with the analyte such that the spores germinate in the presence of the analyte; and
a fluorogenic substrate in contact with the spores, the substrate configured to produce intracellular fluorescent granules after the onset of spore germination.

14. The system of claim 13, wherein the spores require more than one germinant in order to germinate, wherein the germinant is a first co-germinant, and further comprising providing a second co-germinant, the second co-germinant not being associated with the analyte.

15. The system of claim 14, wherein the analyte is E. coli, the spores are B. cereus, the first germinant is L-alanine and the second germinant is inosine.

16. The system of claim 14, wherein the analyte is P. aeruginosa, the spores are B. cereus, the first germinant is L-alanine and the second germinant is inosine.

17. The system of claim 13, wherein the fluorogenic substrate is a tetrazolium salt.

18. The system of claim 17, wherein the tetrazolium salt is 5-cyano-2,3-ditolyl tetrazolium chloride.

19. The system of claim 13, wherein the spores are selected from the group consisting of bacteria, fungi, plants, and yeast.

20. The system of claim 19, wherein the spores are from bacteria of at least one of the genus of Bacillus and Clostridium.

21. The system of claim 13, wherein the spores and substrate are included with in a biosensor configured to receive the sample.

22. The system of claim 13, wherein the analyte is selected from the group consisting of bacteria and viruses.

23. A method for confirming the sterility of a material, the method comprising:
providing a material;
providing a plurality of spores, the spores requiring a germinant in order to germinate;
subjecting the material and the plurality of spores to a same sterilization process;
subsequent to subjecting the material and the plurality of spores to a same sterilization process, contacting the spores with a germinant for a time sufficient to allow for the spores to germinate in response to the germinant;
contacting the spores with a fluorogenic substrate, the substrate configured to produce intracellular fluorescent granules in response to spore germination; and
incubating the spores in contact with the substrate for a time sufficient to allow for the production of the intracellular fluorescent granules.

24. The method of claim 23, further comprising measuring the amount of intracellular fluorescent granules, wherein the amount of intracellular fluorescent granules indicates whether or not the sterilization process was successful.
